(19) United States
(12) Patent Application Publication
(10) Pub. No.: US 2024/0368732 A1
(43) Pub. Date: Nov. 7, 2024

(54) SUSTAINABLE REMELTING LINE FOR ALUMINIUM ALLOY SCRAP

(71) Applicants: CONSTELLIUM ISSOIRE, Issoire (FR); CONSTELLIUM NEUF-BRISACH, Biesheim (FR); CONSTELLIUM MUSCLE SHOALS LLC, Muscle Shoals, AL (US)

(72) Inventors: Marc BERTHERAT, Veyras (CH); Laurent JOUET-PASTRE, Mulhouse (FR); Anne PICHAT, Saint-Cassien (FR); Alain VASSEL, Saint Etienne de Crossey (FR); Emmanuel WAZ, Chambery (FR)

(73) Assignees: CONSTELLIUM ISSOIRE, Issoire (FR); CONSTELLIUM NEUF-BRISACH, Biesheim (FR); CONSTELLIUM MUSCLE SHOALS LLC, Muscle Shoals, AL (US)

(21) Appl. No.: 18/683,841

(22) PCT Filed: Aug. 29, 2022
(86) PCT No.: PCT/FR2022/051620

§ 371 Date: Feb. 15, 2024

(30) Foreign Application Priority Data
Aug. 31, 2021 (FR) FR2109082
Aug. 31, 2021 (FR) FR2109085
Aug. 31, 2021 (FR) FR2109091

(51) Int. Cl. C22B 21/00; C22B 7/00; C22B 9/00; C22B 9/16

(52) U.S. Cl. CPC C22B 21/0092; C22B 7/003; C22B 9/003; C22B 9/16

(57) ABSTRACT

The invention relates to a scrap remelting line comprising at least one storage silo configured to store scrap, at least two induction furnaces for remelting the scrap and obtaining the remelted liquid metal, a means for supplying the scrap to the at least two induction furnaces, at least one furnace receiving the liquid metal (6), and a means for transporting the remelted liquid metal (5, 15) to the receiving furnace. The invention also relates to the method for obtaining liquid metal from scrap remelted in induction furnaces.

### TECHNICAL FIELD

The invention relates to an aluminum scrap remelting line using at least two crucible induction furnaces allowing to supply an intermediate receiving furnace in a continuous or semi-continuous manner. Another object of the invention is a method for remelting aluminum scrap using at least two crucible induction furnaces allowing to supply an intermediate receiving furnace in a continuous or semi-continuous manner.

### PRIOR ART

Recycling aluminum has the advantage of being economical and ecological. The production of secondary aluminum requires up to 95% less energy than primary aluminum and allows the reduction of CO₂ emissions. In order to improve the environmental impact of aluminum production, the aluminum industry seeks to reduce the amount of CO₂ emitted during the recycling step during the scrap remelting step.

The technology used in the profession for the recycling of coated products, in particular UBC, usually uses a dedicated purification line made up of cold preparation steps (shredd, magnetic sorting and air blade separator), hot elimination in a “decoater” of inks, varnishes and other organic materials. The scraps are then typically remelted in gas furnaces. Mention can be made of side-well furnaces. Treatment of the metal by adding salt (1.5% to 8% depending on the case) is necessary to eliminate the oxides contained in the liquid metal (R. Evans, G. Guest, “The aluminum decoating handbook”, Stein Atkinston Stordy, Gillespie Powers internet source). The metal is then transported to the foundry workshop to be cast. Another alternative still using gas technology is to carry out remelting in a rotary furnace. This solution requires a higher salt level than for the side-well furnace (10% to 15%). In this case, the combustion of the organic materials and the remelting of the metal take place simultaneously within the furnace enclosure. Another alternative is remelting in a multi-chamber furnace (“Aluminium recycling” M. Schlesinger, CRC Press, (2007)). The coated scraps are loaded, preheated and stripped in a separate chamber (vertical tunnel or horizontal ramp). The combustion of organic materials helps heat the installation. It is a salt-free method.

All these solutions have the disadvantage of having to be carried out in a gas furnace, which is not adapted for reducing CO₂ emissions.

A solution for reducing CO₂ emissions is to use electric furnaces, provided that the electrical energy used does not emit CO₂. Induction furnace technology is mentioned for UBC recycling in reference works (R. Evans, G. Guest, “The aluminium decoating handbook”, Stein Atkinston Stordy, Gillespie Powers internet source). The electric crucible induction furnace has the advantage of good energy efficiency and generates little metal loss. The large capacity electric channel furnace is sometimes used for the remelting of new manufacturing scraps or beverage cans after decoating (F. Herbulot—Récupération et recyclage de l'aluminium—Techniques de l'Ingénieur—March 2001).

The disclosed induction furnace solutions disclosed in these works do not allow an economically viable industrial application because induction furnaces have reduced melting capacities compared to gas furnaces, which does not allow for a continuous process allowing to supply the holding furnace(s) and/or casting device(s) of aluminum foundries and on the other hand, induction furnaces require having their own scrap.

The object of the invention seeks to overcome this problem by proposing a new design of scrap remelting line (Lay-out) and a method allowing to obtain good cycle efficiency while reducing the amount of CO₂.

### DESCRIPTION OF THE INVENTION

In this text, the generic term “scrap” refers to raw materials for recycling, consisting of aluminum and/or aluminum alloy products resulting from the collection and/or recovery of aluminum and/or aluminum alloy products at different manufacturing steps or products after use. The scrap, if necessary, was sorted to remove any foreign matter.

Unless otherwise stated, reference is made to standard NF EN 12258-3 Sep. 2003 which defines terms relating to aluminum and aluminum alloy scrap, in particular use will be made of the terms “bulk scrap” which corresponds to scrap which has not undergone any compaction operation and from which each piece can be taken individually, “granular scrap” from scrap composed of parts whose dimensions are comprised in a range from a few millimeters to a few centimeters, produced by treating larger parts with machines such as mills, knife or hammer mills or choppers, “coated scrap”, from scrap consisting of parts having any type of coating, for example paint, varnish, printing ink, plastic, paper, metal.

The remelting line design according to the invention allows to obtain productivity which is significantly higher than that which would be obtained with several independent induction furnaces.

A first object of the invention relates to a scrap remelting line comprising at least one storage silo configured to store scrap, at least two induction furnaces for remelting the scrap and obtaining the remelted liquid metal, a means for supplying the scrap to the at least two induction furnaces, at least one furnace receiving the liquid metal, and a means for transporting the remelted liquid metal to the receiving furnace.

It is advantageous for the at least one storage silo to be heat-insulated, optionally the storage silo comprises heating means configured to heat said scrap.

According to the invention, it is important to have at least two induction furnaces, preferably at least two cylindrical induction furnaces, more preferably at least two cylindrical crucible induction furnaces in order to obtain a continuous method allowing to continuously supply the receiving furnace.

It may be advantageous to have at least three induction furnaces, or even more preferably at least four induction furnaces.

Advantageously, at least one receiving furnace is a holding and/or melting furnace which can be supplied with remelted liquid metal and/or with solid metal and/or with primary liquid metal and/or with addition elements intended to obtain a given composition.

It is advantageous for at least one silo to comprise at least one compartment per supplied induction furnace. This arrangement has the advantage of being able to share a silo for at least two induction furnaces, each induction furnace being supplied by a compartment.

Advantageously, the line design comprises a kiln, also designated by kiln. Decoating consists of heating the scrap to a temperature where humidity and organic materials potentially present (for example, paints, protective varnishes, lid seals and other smoke-producing materials) are eliminated, but without heating to too high temperature to prevent the metal from melting. Typically, the temperature is comprised between 450° C. and 540° C. The scrap is heated by thermal transfer with the atmosphere of the furnace, preferably by the heated gas resulting from the post-combustion of the fumes and which circulates in the decoating chamber. This operation allows on the one hand to dry the scrap and on the other hand to eliminate organic materials. Organic materials can be converted into CO₂ in a post-combustion unit to destroy organic molecules. Thus, a scrap that is dry, purified, and without smoke-producing materials is obtained.

It is advantageous for the remelting line to comprise a kiln and a means for transporting decoated scrap which supplies said at least one storage silo with decoated scrap. It is in fact advantageous to have connected the kiln with at least one storage silo in order to be able to benefit from the thermics of the kiln and use hot scrap, typically above a temperature of 100° C.

It is preferable to have an extraction means configured to extract fines, metal and non-metal particles with a particle size of less than 1 mm. This extraction means allows to eliminate in particular metal particles less than 1 mm from the decoated scrap before being introduced into at least one induction furnace.

Advantageously, the remelting line is supplied with granular scrap. Preferably, this granular scrap is obtained after shredding, preferably using a knife mill. This is why it is advantageous to have a mill, preferably a knife mill, optionally said mill is equipped with a grid allowing to obtain a particle size comprised between 5 and 50 mm.

A second object of the invention relates to a method for remelting aluminum scrap which comprises the following steps:
a) Aluminum scrap is supplied to at least one mill, preferably the scrap is in bulk.
b) Said scrap is shredded to obtain granular scrap.
c) At least one kiln is supplied with granular scrap using a granular scrap transport means, typically a belt conveyor.
d) Decoating is carried out in a kiln to obtain decoated scrap.
e) Fines, metal and non-metal dust with a particle size of less than 1 mm is eliminated from the decoated scrap using an extraction means.
f) At least one storage silo is supplied with decoated scrap using a decoated scrap transport means (3),
g) At least two cylindrical crucible induction furnaces are supplied with decoated scrap from at least one storage silo using a decoated scrap supply means.
h) Melting is carried out by induction of the decoated scrap to obtain remelted liquid metal.
i) At least one furnace receiving the liquid metal is supplied with remelted liquid metal from at least two cylindrical crucible induction furnaces using remelted liquid metal transport means (5, 15) to obtain cast liquid metal.

Preferably, during step b) the scrap is shredded with a knife mill to obtain shredded scrap with at least 50% of the individual entities of the shredded scrap with a folding ratio (R) less than or equal to 0.6, where the folding ratio (R) of an individual entity is defined by the expression

$$folding ratio = R = \frac{unfolded surface - folded surface}{unfolded surface}$$

where the folded surface is the maximum surface of the orthogonal projection of the individual entity on a plane and the unfolded surface is the total surface of the same individual entity after being unfolded.

Preferably, said mill is equipped with a grid allowing to obtain shredded scrap with a particle size comprised between 5 and 50 mm, preferably between 8 and 50 mm, more preferably between 8 and 25 mm, or between 8 and 16 mm, the particle size being measured by sieving. Preferably, the shredded scrap has a height less than or equal to 50 mm, preferably less than or equal to 30 mm, even more preferably less than or equal to 15 mm.

The geometry of the shredded scrap is important to facilitate on the one hand the decoating operation and on the other hand the melting operation. Indeed, the inventors realized that by aiming at a folding ratio less than or equal to 0.6, it was possible to better strip the scrap. On the other hand, by also aiming at a particle size comprised between 5 and 50 mm, this allowed to obtain a scrap with a height less than or equal to 50 mm allowing rapid and efficient remelting. Preferably, temperature of the decoated scrap in the silo is maintained at more than 100° C., preferably 150° C. and preferably 200° C. using thermal insulation and/or heating means.

Preferably, if it is necessary to produce a first molten bath in at least one of the induction furnaces, it is possible, before the remelting step g), to load into the cylindrical crucible induction furnace of height H and maximum internal diameter D, massive metal in the form of an aluminum alloy remelting sow of essentially cylindrical shape of height h and maximum diameter d wherein d is in the range 0.7 D to 0.97 D and preferably in the range 0.84 D to 0.92 D.

It is advantageous to use a cylindrical sow whose dimensions are matched to the diameter of the induction furnace according to the relationship d in the range 0.7 D to 0.97 D, to increase the heating efficiency of the induction furnace of the massive metal.

It is advantageous to position the diameter at mid-height h/2 of the remelting sow at a distance from the bottom of the furnace comprised from H/2−H/4 to H/2+H/4.

Preferably steps c) to i) are carried out continuously.

Preferably the furnace receiving the liquid metal is supplied with remelted liquid metal and/or with solid metal and/or with primary liquid metal and/or with addition elements intended to obtain a given composition.

Preferably, the means for transporting remelted liquid metal comprises a chute dimensioned in section to allow a transfer comprised from 100 to 150 tons/h to the furnace receiving the liquid metal (6), preferably the chute is thermally insulated and/or has a pre-heating means.

Preferably, the decoated scrap supply step g) and the melting step h) are regulated in order to guarantee the presence of a scrap bed on the liquid metal bath with a height of at least 300 mm. Preferably, the method according to the invention comprises a maintenance and/or cleaning step. These operations called maintenance and/or cleaning operations are carried out when at least one other induction furnace is in operation.

Preferably, the method according to the invention comprises a step of skimming and/or taking temperature and/or taking samples and/or cleaning the induction furnaces and/or the receiving furnace. Preferably, these steps are automated.

Preferably the melting step in step h) is carried out in at least two successive steps, a first step during which the induction furnace operates at a frequency of 40 to 80 Hz until complete melting of the decoated scrap and a second step during which the induction furnace operates at a frequency greater than or equal to 150 Hz to allow skimming.

Preferably skimming is carried out after a waiting phase lasting from 2 min to 20 min after the start of the second step. This second step and its waiting phase has the advantage of allowing the bath to settle.

Preferably, the remelted liquid metal is taken from a ladle and a wire-guided carriage (16) transports said ladle to the liquid metal receiving furnace.

A third object of the invention relates to a method for casting a raw form, typically a plate or a billet wherein a casting line is supplied with cast liquid metal obtained by the scrap remelting method according to the second object of the invention.

### FIGURES

FIG. 1 is a schematic top view of a first embodiment of the invention of a remelting line with two induction furnaces and a silo.

FIG. 2 is a schematic side view of a first embodiment of the invention.

FIG. 3 is a schematic top view of a variant of the first embodiment of the invention of a remelting line with two induction furnaces and a silo having two compartments.

FIG. 4 is a schematic top view of a second embodiment of the invention of a remelting line with two induction furnaces and two silos.

FIG. 5 is a schematic side view of a second embodiment of the invention.

FIG. 6 is a schematic top view of a third embodiment of the invention of a remelting line with three induction furnaces and a silo having three compartments.

FIG. 7 is a schematic top view of a fourth embodiment of the invention of a remelting line with four induction furnaces and two silos, each silo having two compartments for supplying an induction furnace.

FIG. 8 is a schematic top view of a fifth embodiment of the invention of a remelting line with four induction furnaces and four silos

FIG. 9 is a schematic top view of the storage silo supply.

FIG. 10 is a schematic side view of the storage silo supply.

FIG. 11 is a schematic view of loading an induction furnace with sows and decoated scraps.

FIG. 12 is a diagram of a crucible induction furnace with the stirring movements.

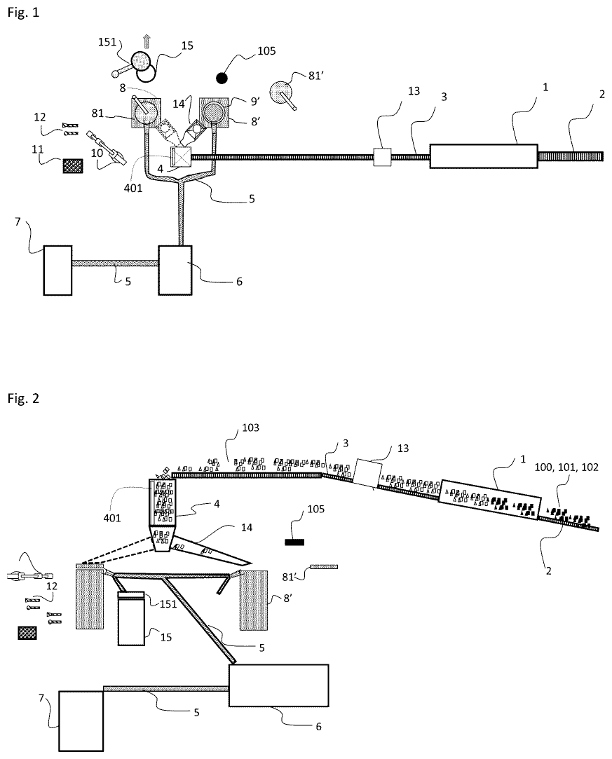

### DETAILED DESCRIPTION

FIGS. 1 (top view) and 2 (schematic side view) illustrate a first embodiment of the invention. Scrap 100 supplies a kiln (1). The scrap is generally coated. Preferably, the scrap capable of being recycled by the method according to the present invention is presented in granules 101. Advantageously, it is preferable that the scrap is shredded using a knife mill and supplied under divided form. In the rest of the text, scrap that has been shredded using a knife mill is called “shredded scrap” 102.

In the following, unless otherwise stated, the proportions in % of individual entities correspond to numerical % of individual entities.

It is preferable that the majority of the individual entities of the granular scrap have a folding ratio less than or equal to 0.6. Advantageously, at least 50% of the individual entities of the granular scrap have a folding ratio (R) less than or equal to 0.6. Preferably, at least 60%, or 70% or 80% of the individual entities of the granular scrap have a folding ratio (R) less than or equal to 0.6. The folding ratio of an individual entity is defined by equation 1.

$$folding ratio = R = \frac{unfolded surface - folded surface}{unfolded surface} \qquad ( equation 1 )$$

The inventors have found that it is possible to obtain such a folding ratio when the bulk scrap is shredded with a knife mill 20. The inventors have indeed found that the use of hammer mills is not recommended to obtain the desired geometries, in particular a folding ratio less than or equal to 0.6. Indeed, the scrap milling operation carried out with a hammer mill tends to wrinkle the loose scrap and form “balls” which have a folding ratio greater than 0.6.

Thus, preferably, at least 50% of the individual entities of the shredded scrap which enters the kiln 1 has a folding ratio (R) less than or equal to 0.6. Preferably, at least 60%, or 70% or 80% of the individual entities of the shredded scrap have a folding ratio (R), less than or equal to 0.5 or 0.4.

The folding ratio of an individual entity of the shredded scrap quantifies how that individual entity was folded during the crushing step. The higher this ratio, the more the individual entity was folded and is therefore compact, particularly in globular form. The lower the ratio, the more planar the individual entity. The inventors noted that it was necessary to have a folding ratio less than or equal to 0.6 to avoid the use of salts, called recycling flow, to separate the oxides from the liquid metal, during the step of remelting in one of the induction furnaces.

The folded surface is the apparent surface of an individual entity of shredded scrap. The folded surface is defined as the maximum surface of the orthogonal projection of the individual entity onto a plane.

The unfolded surface corresponds to the developed surface of an individual entity of shredded scrap. The unfolded surface is defined as the total surface of the individual entity of shredded scrap after being unfolded. It should be noted that knowing the thickness and the mass and the average density of the individual entity the unfolded surface can be easily determined. The unfolded surface can also be obtained by unfolding the individual entity.

Advantageously, at least 50% of the individual entities of the shredded scrap have a particle size comprised between 5 and 50 mm, preferably between 8 and 50 mm, more preferably between 8 and 16 mm, the particle size being measured by sieving.

Advantageously, the shredded scrap is obtained according to a method comprising a step of shredding with a knife mill, equipped with a grid adapted to obtain a particle size comprised between 5 and 50 mm, preferably between 8 and 50 mm, even more preferably 8 to 16 mm.

Advantageously, the individual entity of shredded scrap is substantially flat. An individual entity of shredded scrap can fit into a fictitious volume defined by a length, width and height. The flatness of the individual entity of shredded scrap is characterized by the minimum height of the fictitious volume, expressed in mm. To measure the height (h), an individual entity of shredded scrap is placed on a flatness ruler in such a way as to obtain the minimum height of the entity.

The flatness ruler can be any flat surface, such as a measuring marble.

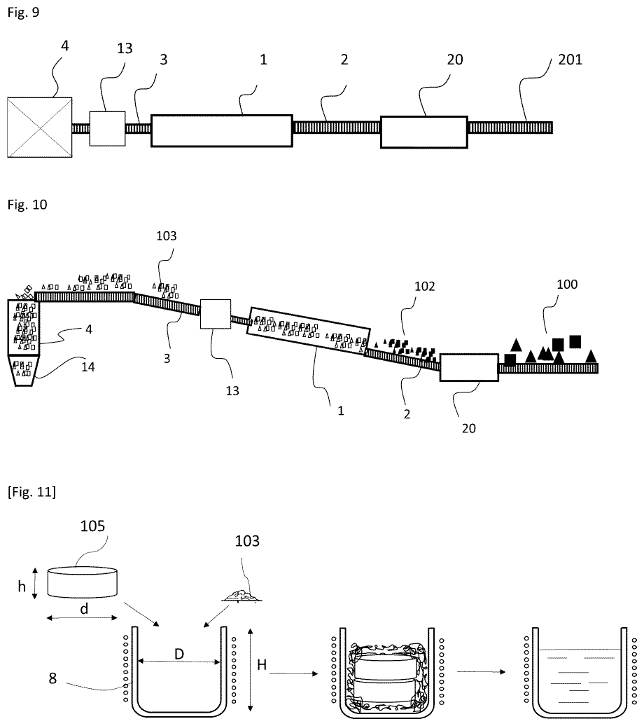

Advantageously at least 50% or 60% or 70% or 80% of the individual entities of the shredded scrap have a height less than or equal to 50 mm, or 40 mm, or 30 mm, or 20 mm or 15 mm or 10 mm or 5 mm. The inventors have found that the height of an individual entity of shredded scrap is not modified by the decoating operation. The inventors believe that having a majority of individual entities of shredded scrap having a height less than or equal to 50 mm, or 40 mm, or 30 mm, or 20 mm or 15 mm or 10 mm or 5 mm, favors their arrangement in the form of stacked strata and improves their submergence in the liquid metal bath of the induction furnace. Advantageously, the density of the shredded scrap is comprised between 0.2 and 0.4 t/m³. This preliminary shredding step in a knife mill equipped with a grid corresponds to a method for remelting aluminum alloy scrap comprising the following successive steps shown in FIG. 9.
scrap based on aluminum alloys 100, preferably bulk scrap, usually coated scrap, typically from aluminum household packaging, typically used aluminum beverage cans is supplied,
said scrap is shredded in a knife mill 20, optionally provided with a grid, to obtain shredded scrap 102 consisting of individual entities,
scrap 102 is supplied to a kiln 1 by transport means 2,
said shredded scrap is stripped to obtain decoated scrap 103,
a storage silo 4 is supplied with decoated scrap 103 by a transport means 3. Preferably at the output of the kiln 1 the fines, metal or non-metal particles with a particle size less than 1 mm are extracted by an extraction means 13.

“Fines” refers to metal or non-metal particles with a particle size of less than 1 mm, which resemble dust. The presence of fines is not desirable during the remelting operation because metal fines tend to oxidize and not be able to be immersed in the molten bath.

Scrap supply (2) is suitable for transporting cold or hot scrap.

The kiln 1 allows to eliminate, for example, paints, protective varnishes, lid seals and other smoke-producing materials at a temperature comprised between 450° C. and 540° C. A drying step can be carried out after decoating.

The inventors have noted that the decoating or drying operation does not modify the folding ratio, the flatness or the shape of the scrap. The decoated scrap therefore has the same folding ratio, the same flatness, the same particle size as the supplied shredded scrap. The density of the decoated scrap is slightly modified compared to that of the shredded scrap and remains comprised between 0.2 and 0.4 t/m³.

The inventors have noted that it is preferable for the scrap which enters the kiln to be folded on itself as little as possible so that the coated surfaces are in direct contact with the atmosphere of the kiln and therefore the exchanges of masses and heat on the surface of the scrap occurring during the decoating operation can be done as efficiently as possible. This is why it is advantageous to treat mainly shredded scrap, with a folding ratio less than or equal to 0.6. Decoated scrap transportation means (3) allow to supply a storage silo (4), which is preferably heat-insulated at a temperature above 100° C. and/or equipped with heating means (401). The temperature of the decoated scrap in the silos is preferably comprised between 200° C. and 450° C. before being loaded into the liquid metal. Means (13) for extracting fine scrap particles, typically particles less than 0.1 mm in size, are positioned on the decoated scrap conveyor. These means are advantageously placed at a sufficient distance from the outlet of the kiln (1), typically at least 5 m, so that the scrap is no longer too agglomerated by the heat. It is also possible to consider placing these extraction means (13) in the kiln so as to benefit from the mixing thereof.

The scrap, before decoating, has an initial residual carbon amount typically of at least 1.5% by weight. Advantageously, the decoated scrap, after the decoating step, has an amount of residual carbon less than 0.3% by weight, preferably less than 0.2% by weight, even more preferably less than 0.1% by weight. The amount of residual carbon in % by weight can be measured using a suitable instrument such as those supplied by the LECO company. The analysis consists of maintaining a given mass of scrap in a furnace after the decoating step at a temperature comprised between 250° C. to 550° C. under argon flow and converting the fumes into CO₂ in a catalysis furnace. The carbon measurement is evaluated by measuring the proportion of CO₂ via an infrared probe.

Two induction furnaces (8) are supplied with decoated scrap using decoated scrap supply means (14).

Decoated scrap supply means (14) are hoppers, preferably comprising a sieve allowing to eliminate fine particles of scrap, typically less than 1 mm.

The induction furnaces (8) comprise a lid (81) which is closed during melting. Typically a bath starter is maintained when loading the induction furnace to accelerate melting.

If necessary, it is possible to prepare a bath starter. The initial liquid metal bath starter can be obtained from clean scrap obtained after the decoating step or from massive waste, such as cutting scraps or cutting skeletons of thin or thick sheets, said massive waste being made of an alloy of composition compatible with the clean, and preferably purer scrap, whose composition will not harm the final composition. Typically, the massive waste is aluminum alloys of the 3XXX series, typically an AA3104 type alloy. The liquid metal bath starter can also be obtained by melting remelted ingots of an alloy of 1xxx, 3xxx, 5xxx, 6xxx, 8xxx type compatible with clean scrap. In the case of successive castings, the liquid metal bath starter may advantageously consist of the remainder of the previous casting.

The volume of the bath starter represents approximately 30% to 60% of the total volume of the induction furnace, typically half of the capacity of the induction furnace. If the volume of the bath starter is too low, the risk is that the bath starter does not have sufficient thermal capacity to remain in the liquid state and solidifies in the furnace. Operation with a bath starter allows advantageous melting rates of 2 t/h to 4 t/h to be obtained.

Each induction furnace can also be supplied with massive scrap, in particular from factory manufacturing or other massive waste, not shown in FIG. 1.

Advantageously, the induction furnaces 8 are cylindrical induction furnaces, preferably cylindrical crucible induction furnaces.

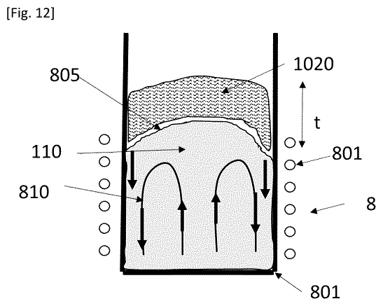

The cylindrical crucible induction furnace (8) shown for example in FIG. 12 essentially consists of one or two inductor coils 801 cooled by circulation of heat transfer fluid, surrounding a rammed-earth refractory lining or a pre-baked refractory shell, forming the crucible 801 wherein the metal mass to be melted is placed.

Advantageously, shown in FIG. 11, the cylindrical crucible induction furnace 8 can be supplied in the form of a sow 105 of essentially cylindrical shape of height h and maximum diameter d. Said sow can be loaded into the cylindrical induction furnace of height H and maximum internal diameter D wherein the direction of the height of said sow is substantially parallel to the direction of the height of the furnace. The maximum diameter of dimension d of said sow is advantageously in the range from 0.7 D to 0.97 D and preferably in the range 0.84 D to 0.92 D. In an advantageous embodiment, the cylindrical crucible induction furnace is first partially filled with decoated scrap, then the sow of essentially cylindrical shape of height h and maximum diameter d is introduced then decoated scrap is introduced again, particularly in the space remaining between the sow and the walls of the furnace, the loading being finally completed by decoated scrap.

It is advantageous for melting to be faster and less energy consuming if at least one sow is positioned around the mid-height of the furnace. Thus in an advantageous embodiment the diameter positioned at mid-height h/2 of the sow of essentially cylindrical shape is located at a distance from the bottom of the furnace, that is to say from the bottom of the crucible, comprised between H/2−H/4 and H/2+H/4 and preferably between H/2−H/5 and H/2+H/5.

Regardless of the type of load (massive or in the form of scrap), the load is melted by induction to obtain a remelted liquid metal bath. Melting can be carried out under an inert atmosphere or in ambient air, with or without a lid. The power and frequency used are chosen according to the furnace used and the load.

The inventors have noted that it is advantageous for the bath to be covered by a floating decoated scrap bed 1020 as shown in FIG. 12 on the surface of the liquid bath 110 for most of the duration of the remelting step. The presence of a floating decoated scrap bed 1020 allows to protect the surface of the liquid metal bath from oxidation. Most of the duration of the remelting step corresponds to a duration of at least 70% or 80% or 90% of the duration of the remelting step. The duration of the remelting step is defined by the moment when the loading of the scraps is started and the end of loading. The end of loading being defined by the moment when the amount of molten metal in the induction furnace reaches its maximum filling level. Advantageously, the thickness t of the floating decoated scrap bed 1020 is at least 300 mm, advantageously at least 1000 mm. The floating decoated scrap bed allows the continuous supply of the liquid metal bath until its complete dissolution.

The inventors have noted that the submergence of the scrap is facilitated in the liquid metal bath when shredded scrap according to the invention is used. By the grain size and flatness (defined here by the height) of the individual entities used, they are organized in the form of stacked strata, like stacked cards arranged parallel according to their largest face. This effectively protects the liquid metal bath and facilitates the introduction of the individual entities into the liquid metal bath. Said individual entities slide over each other and plunge along the wall of the crucible.

It is advantageous that an individual entity of decoated scrap is kept on the surface of the liquid metal bath for a period of at most 2 min, preferably between 30 s and 90 s, in order to avoid its oxidation. It is therefore important to encourage their submergence in the liquid metal bath. Advantageously, the submergence of the scraps is improved by acting on the circulation speed field of the liquid metal bath so as to obtain a descending speed field along the walls of the crucible 810. This descending speed field creates a vortex which facilitates the immersion of scraps. This descending circulation speed field results from electromagnetic forces, called Laplace forces, well known in the design of crucible induction furnaces. The descending speed field along the walls of the crucible facilitates the submergence of individual entities of decoated scrap present in the floating decoated scrap bed.

Creating a vortex on the surface of the bath using electromagnetic forces is not possible if a channel induction furnace is used. According to the inventors, a channel induction furnace does not allow to obtain favorable conditions for remelting scraps according to the invention: the absence of vortices on the surface of the bath means that if the scraps according to the invention are introduced, they will stack on top of each other, make an insulating mattress and will not be immersed in the liquid metal bath. If the scraps are kept above the liquid metal bath for a long time, the scraps can oxidize and reduce the metal yield.

The descending speed field along the walls of the crucible is obtained by selecting the frequency of the induction furnace. Selecting a frequency between 50 Hz and 150 Hz, preferably around 60 Hz, allows to obtain a descending speed field. The inventors have found that this descending speed field induces the formation of a dome 805 at the upper surface of the liquid metal bath. This dome shape allows to accelerate the submergence of the scrap in the liquid. It is also possible to act on the power of the furnace to modify the descending speed field. It is possible to adapt the frequency and/or power of the furnace according to the filling level of the furnace as magneto-hydrodynamic calculations can show. Stacking individual entities of decoated scrap associated with a descending speed field is particularly advantageous for the submergence of scrap in liquid metal. Advantageously, the power and frequency parameters of the furnace are adapted according to the thickness of the decoated scrap bed and the phase of the cycle (start, end of remelting, temperature rise and hold).

Melting can be carried out under an inert atmosphere or in ambient air, with or without a lid. The power and frequency used are selected according to the furnace used and the load. The frequency is particularly adapted to the size of the induction furnace.

It should be noted that in one embodiment the melting can be started before the complete introduction of the load: once the load is partially melted, it is possible in certain cases to resume the loading cycle using the supply means (14).

Optionally; the alloy elements for analysis are then placed in the furnace to achieve a targeted composition. The alloy elements are generally added in the form of highly alloyed aluminum alloys in a single element or containing these elements or in the form of pure addition metals. The different forms used to add alloy elements are known by the acronym “MAAM” which means “mother alloys and addition metals”.

The inventors noted that for a density comprised between 0.2 and 0.4 t/m³, the scrap is quickly submerged in the liquid metal bath. This prevents oxidation of the scrap and maximizes the metal yield during melting.

Induction furnaces allow to obtain remelted liquid metal 110. Means for transporting remelted liquid metal 5, 15 are available for emptying the induction furnaces when the scrap is melted. It is advantageous to have induction furnaces that can tilt in one or two directions in order to be able to carry out either liquid transport in a ladle or towards a channel via the transfer chute 5. The transfer chute 5 allows to supply the receiving furnace with remelted liquid metal 6. This chute is preferably optimized in section, insulation, pre-heating to allow rapid transfer comprised between 100-150 tons/h.

The receiving furnace can also be supplied by ladles 15. They are filled, either by siphoning the induction furnace, or by pouring. They are preferentially used if the remelted liquid metal receiving furnace 6 is full or if the remelted liquid metal has a composition incompatible with that of the liquid metal present in the remelted liquid metal receiving furnace. The ladles 15 can be preheated in ladle preheaters (not shown). The ladles 15 can be closed using a lid 151. They can be moved as indicated by the arrow, for example using a ladle transporter truck or by wire-guided trolleys (not shown), either towards the receiving furnace 6 or towards another furnace. It is advantageous for the steps of skimming, temperature taking, sample taking and cleaning of induction furnaces or any other step necessary for the operation of induction furnaces to be fully automated. For each induction furnace, a tool manipulator robot 10 can grab the available tools 12 to carry out these operations in an automated manner. The list of tools 12 can be a skimming shovel, and/or a pin ladle, and/or a wall cleaning scraper, and/or a temperature measuring thermocouple or any other tool that can be adapted to the operation of an induction furnace. The dirt collected by the cleaning scraper is poured into the dirt tank 11 disposed nearby.

Preferably, the melting step is carried out in at least two steps:

A first step is carried out at a frequency comprised from 40 to 150 Hz, preferably 50 Hz to 70 Hz. During this first step, the decoated scraps are introduced into the induction furnace. It is important to ensure their submergence by creating a dome on the surface of the liquid metal and a descending field along the walls of the crucible. This can be obtained in particular by working at a frequency of 40 to 150 Hz, preferably 50 Hz to 70 Hz. The furnace power is typically greater than 40% of the nominal power.

The second step is intended to skim the furnace. When all the scrap introduced is melted, it is preferable to skim the liquid metal to remove the oxides and/or dirt formed. To enable effective skimming, it is important to sediment the bath. The mixing of the bath is then stopped by adjusting the frequency of the furnace to a frequency greater than 150 Hz, typically comprised between 160 Hz and 400 Hz. The furnace power can also be reduced, typically to a power less than or equal to 20% of the rated power of the furnace. However, it is important to ensure that the temperature of the liquid metal is maintained between 680° C. and 750° C., preferably between 680° C. and 730° C., to avoid any freezing of the bath. Skimming is carried out after a waiting phase typically comprised from 2 minutes to 20 minutes, preferably 2 minutes to 15 minutes, even more preferably 5 minutes to 10 minutes after the start of the second step. The receiving furnace 6 can be supplied by the remelted liquid metal obtained in the induction furnaces, but can also be supplied by massive scrap, in particular from the manufacturing of the factory or other massive waste.

The receiving furnace (6) can be analyzed. Optionally; the alloy elements for analysis are placed in the furnace to achieve a targeted composition. The alloy elements are generally added in the form of highly alloyed aluminum alloys in a single element or containing these elements or in the form of pure addition metals. The different forms used to add alloy elements are known by the acronym “MAAM” which means “mother alloys and addition metals”.

The receiving furnace (6) can supply a casting line 7.

It is indeed advantageous to connect the receiving furnace 6 to a casting line 7 using a chute 5 or any other suitable means. A casting line comprises a direct-cooling vertical semi-continuous casting device for plates or billets including a cylindrical or rectangular tubular vertical semi-continuous casting mold, with open ends, with the exception of the lower end closed at the start of casting by a false bottom which moves downwards thanks to a descender during the casting of the plate or billet, the upper end being intended for the supply of metal, the lower end for the outlet of the plate or billet, said upper end being provided with a means for supplying cast liquid metal, typically nozzles or chutes, and optionally with a distributor capable of being introduced into the mold, into the liquid metal marsh in contact with the solidification front. According to the invention, the means for supplying cast liquid metal to the casting device is connected to the receiving furnace 6.

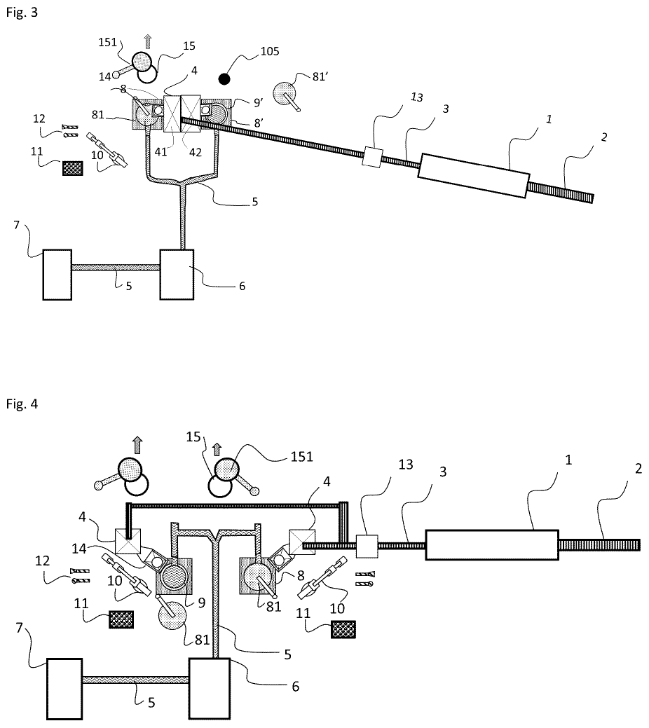

FIG. 3 illustrates a variant of the first embodiment wherein the induction furnaces (8) are disposed around a single storage silo (4) which supplies them with scrap. The silo in this variant comprises at least two compartments (41, 42) which supplies each of the two induction furnaces.

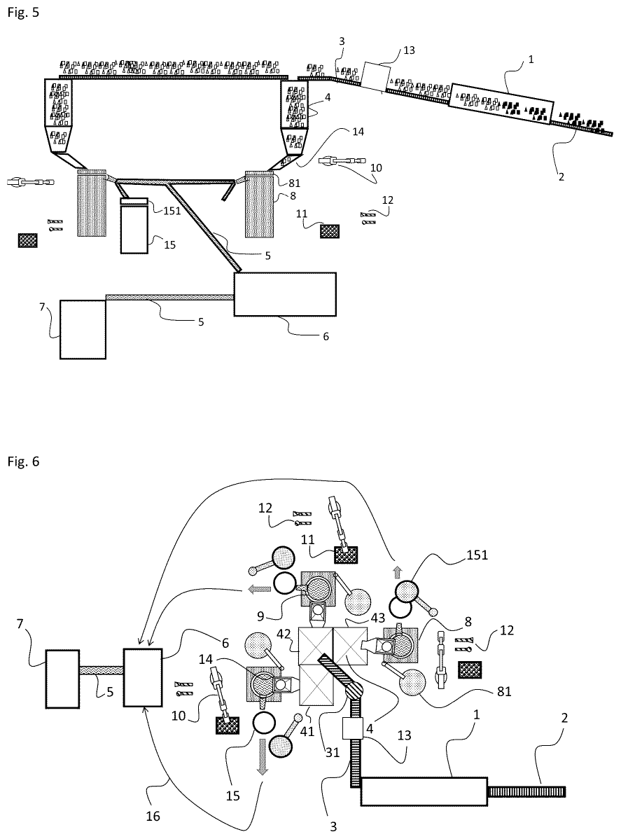

FIG. 4 (top view) and FIG. 5 (side view) illustrate a second embodiment wherein the induction furnaces (8) are each supplied by a separate storage silo (4). This configuration allows to supply each of the silos with different scraps. Different means aluminum alloy scraps of different chemical composition. This can have an advantage when in a factory, there are different sources of scrap that are well identified in terms of chemical composition. This type of configuration with separate silo can be used regardless of the number of induction furnaces used.

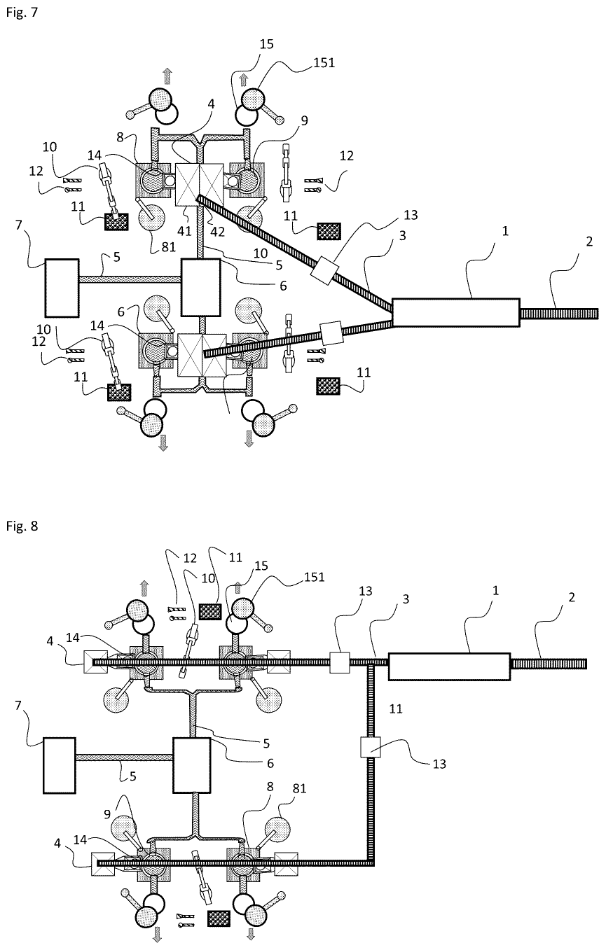

FIG. 6 illustrates a third embodiment wherein three induction furnaces (8) are supplied by a silo (4) comprising three compartments (41, 42, 43). A distributor (31) allows to supply the three silos. In this embodiment, the furnace receiving the liquid metal is not supplied by a chute but only by the ladles (15) transported by the wire-guided carriages (16) symbolized by arrows. FIG. 7 illustrates a fourth embodiment wherein four induction furnaces (8) are supplied by two silos (4) each comprising two compartments (41, 42). The receiving furnace (6) is in a central position which allows to optimize the analysis of metal as a function of the composition of the remelted liquid metal contained in each of the induction furnaces.

FIG. 8 illustrates a fifth embodiment wherein four induction furnaces (8) are supplied by four silos (4) and wherein the tool manipulator robots (10), the dirt tanks (11) and the tools (12) are shared for two furnaces.

1. A scrap remelting line comprising
at least one storage silo configured to store scrap (4),
at least two induction furnaces (8, 8′) for remelting said scrap and obtaining the remelted liquid metal, preferably at least two cylindrical induction furnaces, more preferably at least two cylindrical crucible induction furnaces (9),
a means (14) for supplying the scrap to the at least two induction furnaces,
at least one furnace receiving the liquid metal (6)
a means for transporting the remelted liquid metal (5, 15) to the furnace receiving the liquid metal (6).

2. The scrap remelting line according to claim 1 wherein said at least one storage silo (4) is heat-insulated, optionally it comprises heating means (401) configured to heat said scrap.

3. The scrap remelting line according to claim 1 comprising at least three and preferably at least four induction furnaces (8).

4. The scrap remelting line according to claim 1 wherein said at least one furnace receiving the liquid metal (6) is a holding and/or melting furnace which can be supplied with remelted liquid metal and/or with solid metal and/or with primary liquid metal and/or with addition elements intended to obtain a given composition.

5. The scrap remelting line according to claim 1 wherein said at least one silo comprises at least one compartment (41, 42, 43) per supplied induction furnace.

6. The scrap remelting line according to claim 1 comprising a kiln (1) and means (3) for transporting decoated scrap which supplies said at least one storage silo (4) with decoated scrap.

7. The scrap remelting line according to claim 6 comprising extraction means (13) configured to extract fines, metal and non-metal particles with a particle size of less than 1 mm.

8. The scrap remelting line according to claim 6 comprising a mill (20), preferably a knife mill, optionally said mill is equipped with a grid allowing to obtain a particle size comprised between 5 and 50 mm.

9. A method for remelting aluminum scrap comprising the following steps:
a. Aluminum scrap (100) is supplied to at least one mill (20),
b. Said scrap (100) is shredded to obtain granular scrap (101),
c. At least one kiln (1) is supplied with granular scrap (101) using a granular scrap transport means,
d. A decoating is carried out in a kiln (1) to obtain decoated scrap (103),
e. Fines, metal and non-metal dust with a particle size of less than 1 mm is eliminated from the decoated scrap using an extraction means (13),
f. At least one storage silo (4) is supplied with decoated scrap (103) using a decoated scrap transport means (3),
g. At least two cylindrical crucible induction furnaces (8) are supplied with decoated scrap from at least one storage silo (4) using a decoated scrap supply means (14),
h. Melting is carried out by induction of the decoated scrap to obtain remelted liquid metal,
i. At least one furnace receiving the liquid metal (6) is supplied with remelted liquid metal from at least two cylindrical crucible induction furnaces using remelted liquid metal transport means (5, 15) to obtain cast liquid metal.

10. The method for remelting aluminum scrap according to claim 9 characterized in that during step b) the scrap is shredded with a knife mill to obtain shredded scrap (102) with at least 50% of the individual entities of the shredded scrap with a folding ratio (R) less than or equal to 0.6,
where the folding ratio (R) of an individual entity is defined by the expression
$$folding ratio = R = \frac{unfolded surface - folded surface}{unfolded surface}$$
where the folded surface is the maximum surface of the orthogonal projection of the individual entity on a plane and the unfolded surface is the total surface of the same individual entity after being unfolded.

11. The method for remelting aluminum scrap according to claim 10, characterized in that said mill is equipped with a grid allowing to obtain shredded scrap with a particle size comprised between 5 and 50 mm, preferably between 8 and 50 mm, more preferably between 8 and 16 mm, the particle size being measured by sieving.

12. The method for remelting aluminum scrap according to claim 10 characterized in that the shredded scrap has a height less than or equal to 50 mm, preferably less than or equal to 30 mm, even more preferably less than or equal to 15 mm.

13. The method according to claim 9 wherein the temperature of the decoated scrap in the silo (4, 41, 42, 43) is maintained at more than 100° C., preferably 150° C. and preferably 200° C. using thermal insulation and/or heating means (401).

14. The method according to claim 9 wherein before the remelting step g), it is possible to load into the cylindrical crucible induction furnace of height H and maximum internal diameter D, an aluminum alloy remelting sow of essentially cylindrical shape (105) of height h and maximum diameter d wherein d is in the range 0.7 D to 0.97 D and preferably in the range 0.84 D to 0.92 D.

15. The method according to claim 14 wherein the diameter positioned at mid-height h/2 of said remelting sow is located at a distance from the bottom of the furnace comprised from H/2−H/4 to H/2+H/4.

16. The method according to claim 9 wherein the steps c) to i) are carried out continuously.

17. The method according to claim 9 wherein the furnace receiving the liquid metal (6) is supplied with remelted liquid metal and/or with solid metal and/or with primary liquid metal and/or with addition elements intended to obtain a given composition.

18. The method according to claim 9 wherein the means for transporting remelted liquid metal comprises a chute (5) dimensioned in section to allow a transfer comprised from 100 to 150 tons/h to the furnace receiving the liquid metal (6), preferably the chute is thermally insulated and/or has a pre-heating means.

19. The method according to claim 9 wherein the decoated scrap supply step g) and the melting step h) are regulated in order to guarantee the presence of a scrap bed on the liquid metal bath with a height of at least 300 mm.

20. The method according to claim 9 comprising operations (10, 11, 12) of maintenance and/or cleaning of at least one of the two induction furnaces, these operations called maintenance and/or cleaning operations are carried out when at least one other induction furnace is in operation.

21. The method according to claim 20 comprising a step of skimming and/or taking temperature and/or taking samples and/or cleaning the induction furnaces and/or the receiving furnace, advantageously these steps are automated (10, 11, 12).

22. The method according to claim 21 wherein the melting step in step h) is carried out in at least two successive steps, a first step during which the induction furnace operates at a frequency of 40 to 80 Hz until complete melting of the decoated scrap and a second step during which the induction furnace operates at a frequency greater than or equal to 150 Hz to allow skimming.

23. The method according to claim 22 wherein the skimming is carried out after a waiting phase lasting from 2 min to 20 min after the start of the second step.

24. The method according to claim 9 wherein the remelted liquid metal is taken from a ladle (15) and where a wire-guided carriage (16) transports said ladle to the liquid metal receiving furnace (6).

25. A method for casting a raw form, typically a plate or a billet, wherein a casting line (7) is supplied with cast liquid metal obtained by the method according to claim 8.
